(19) United States
(12) Patent Application Publication
(10) Pub. No.: US 2016/0167488 A1
(43) Pub. Date: Jun. 16, 2016

(54) REAR WINDOW ASSEMBLY WITH VERTICALLY MOVABLE WINDOW PANEL

(71) Applicant: MAGNA MIRRORS OF AMERICA, INC., Holland, MI (US)

(72) Inventor: Darin J. Snider, Holland, MI (US)

(21) Appl. No.: 14/967,414

(22) Filed: Dec. 14, 2015

Related U.S. Application Data
(60) Provisional application No. 62/104,289, filed on Jan. 16, 2015.
(60) Provisional application No. 62/091,867, filed on Dec. 15, 2014.

(51) Int. Cl. B60J 1/18; B60J 1/00

(52) U.S. Cl. CPC B60J 1/1861; B60J 1/007

(57) ABSTRACT

A rear window assembly for a vehicle includes upper and side frame portions configured to be attached at a vehicle, first and second fixed window panels having an opening therebetween, and a movable window panel. The upper and side frame portions are attached at the inner surfaces of the fixed window panels. The fixed window panels have respective side channels disposed along an inboard side region thereof. The movable window panel includes a side guide element disposed at its inner surface and along opposite side regions thereof. The side guide elements are movably received along the side channels such that the movable window panel is movable between a raised closed position and a lowered opened position. When the movable window panel is at least partially closed, the outer surface of the movable window panel is generally flush or generally coplanar with the outer surfaces of the fixed window panels.

### CROSS REFERENCE TO RELATED APPLICATIONS

The present application claims the filing benefits of U.S. provisional applications, Ser. No. 62/104,289, filed Jan. 16, 2015, and Ser. No. 62/091,867, filed Dec. 15, 2014, which are hereby incorporated herein by reference in their entireties.

### FIELD OF THE INVENTION

The present invention relates to a rear window assembly for a vehicle and, more particularly, a rear window assembly for a pickup truck or the like.

### BACKGROUND OF THE INVENTION

It is known to provide a rear slider window assembly for an opening of a vehicle, such as a rear slider window assembly for a rear opening of a pickup truck. Conventional rear window assemblies for rear openings of trucks or the like typically include three or more panels, such as two fixed window panels and a movable window panel. The movable window panel may move horizontally along rails across the window assembly or may move vertically downward to open the window. An example of such a vertically movable window is shown in U.S. Pat. No. 6,691,464, which is hereby incorporated herein by reference in its entirety.

### SUMMARY OF THE INVENTION

The present invention provides a rear window assembly that has a vertically movable window panel movably disposed between two fixed window panels. An exterior surface of the movable window panel and the exterior surfaces of the fixed window panels are generally flush or coplanar when the movable window panel is in its closed state, so as to provide a generally flush or continuous glass surface at the exterior of the window assembly. The movable window panel includes a guide element disposed at the interior surface of the panel and along both side perimeter regions and along an upper perimeter region. The fixed window panels include a channel element disposed at the interior surface of the panels and along the side perimeter region adjacent to the movable panel. The channel elements movably or slidably receive the guide elements of the movable window panel to allow for vertical movement of the movable panel relative to the side fixed panels. An upper channel is disposed at the vehicle sheet metal and receives the upper guide element of the movable window panel when the movable window panel is moved vertically upwardly to its closed position.

These and other objects, advantages, purposes and features of the present invention will become apparent upon review of the following specification in conjunction with the drawings.

### BRIEF DESCRIPTION OF THE DRAWINGS

FIG. 1 is a rear perspective view of a pickup truck having a rear window assembly in accordance with the present invention;

FIG. 2 is a perspective view of the rear window assembly of the present invention at the pickup truck;

FIG. 3 is an inside perspective view of the rear window assembly of the present invention;

FIG. 4 is a rear elevation of the rear window assembly of FIG. 2;

FIG. 5A is a sectional view taken along the line A-A in FIG. 4;

FIG. 5B is a sectional view taken along the line B-B in FIG. 4;

FIG. 5C is a sectional view taken along the line C-C in FIG. 4;

FIG. 5D is a sectional view taken along the line D-D in FIG. 4;

FIG. 5E is a sectional view taken along the line E-E in FIG. 4;

FIG. 5F is a sectional view taken along the line F-F in FIG. 4;

FIG. 6A is a sectional view similar to FIG. 5A of another window assembly of the present invention;

FIG. 6B is a sectional view similar to FIG. 5B of another window assembly of the present invention;

FIG. 6C is a sectional view similar to FIG. 5C of another window assembly of the present invention;

FIG. 6D is a sectional view similar to FIG. 5D of another window assembly of the present invention; and

FIG. 6E is a sectional view similar to FIG. 5E of another window assembly of the present invention.

### DESCRIPTION OF THE PREFERRED EMBODIMENTS

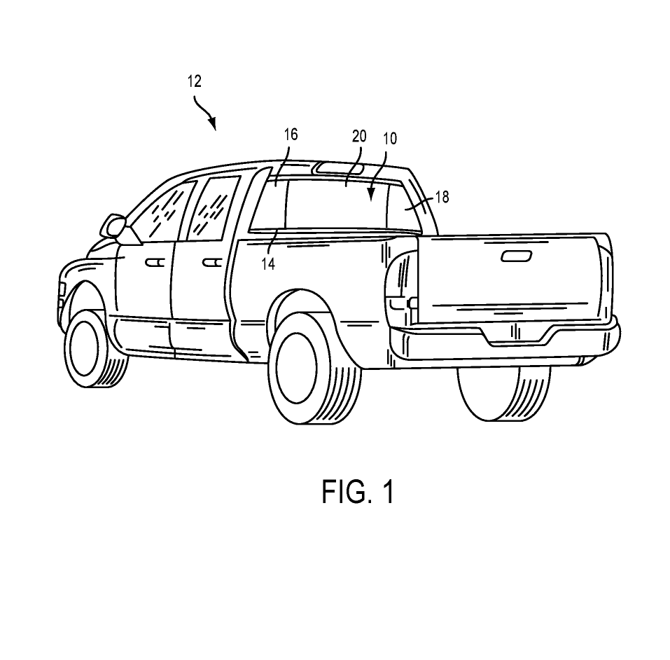

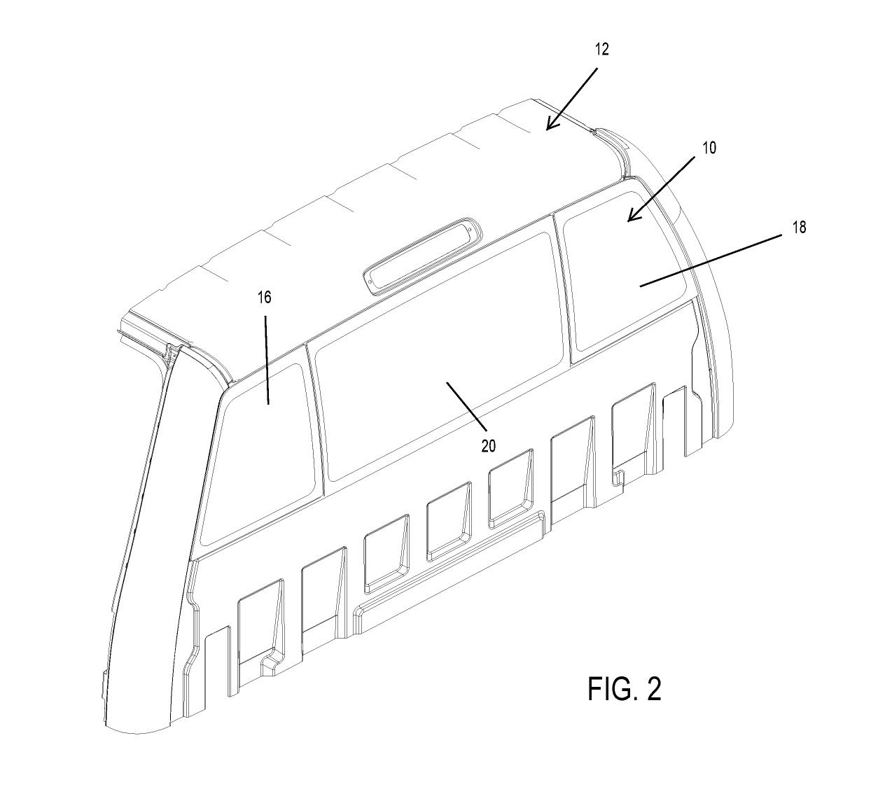

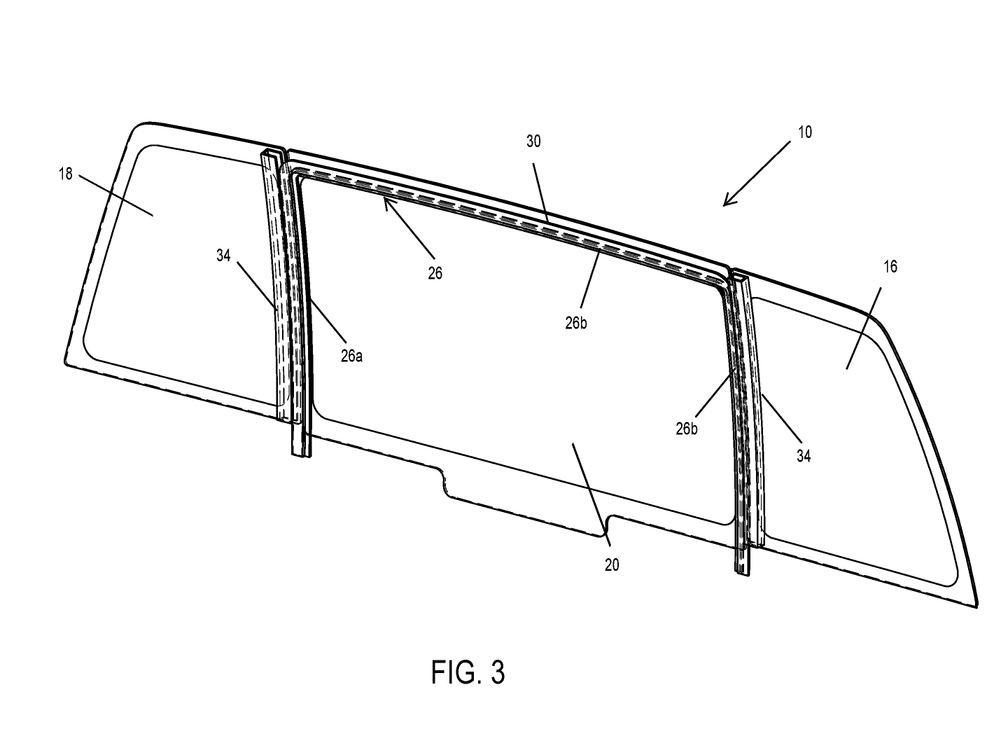

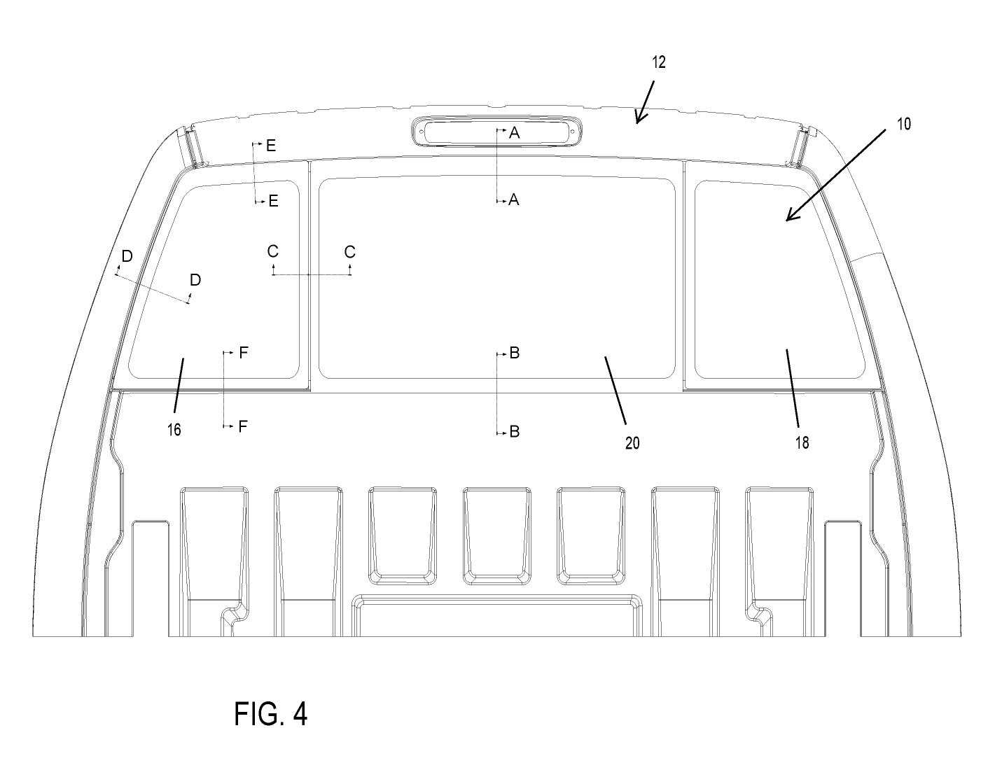

Referring now to the drawings and the illustrative embodiments depicted therein, a rear window assembly 10 of a vehicle 12 (such as a pickup truck or the like) includes a window frame 14, a pair of side fixed window panels 16, 18 and a movable window panel 20 that is generally vertically movable relative to frame 14 and fixed window panels 16, 18 between a lowered opened position and a raised closed position (FIGS. 1 and 2). Frame 14 comprises an upper portion 22 and side portions 24 for attaching the window assembly to the vehicle. The side regions of movable window panel 20 include guide elements that are movably or slidably received in and along respective side channels at the fixed window panels 16, 18, as discussed below. When the movable window panel is at least partially raised or closed, an outer surface 20a (or rearward surface) of the movable window panel 20 is generally flush with or coplanar with the outer surfaces 16a, 18a (or rearward surfaces) of the fixed window panels 16, 18, such that the window assembly 10 provides a generally flush or continuous glass surface at the exterior or rear of the window assembly, as also discussed below.

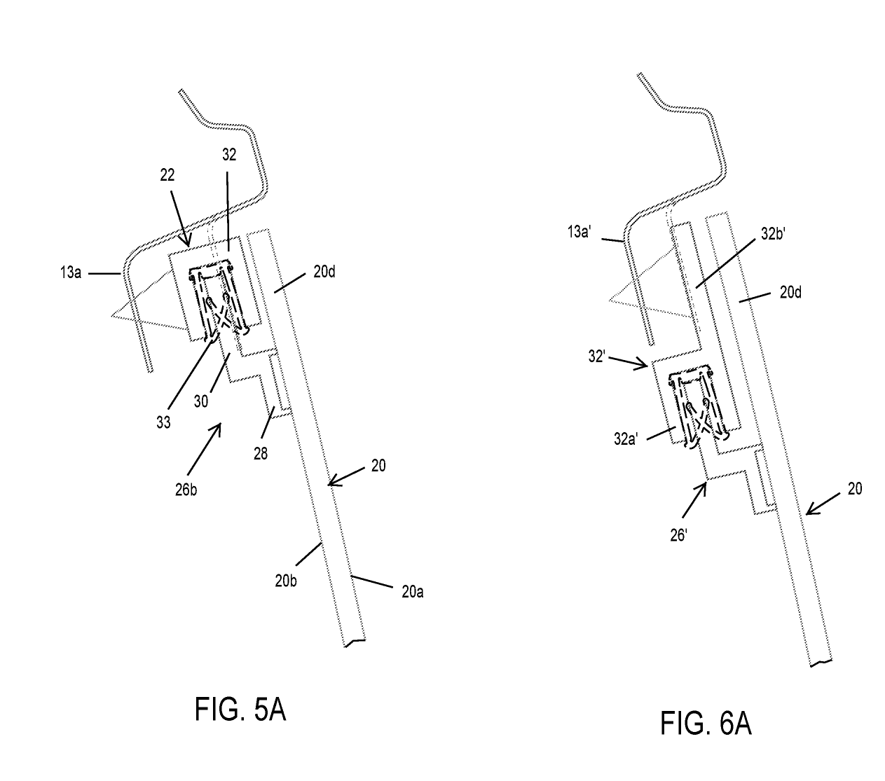

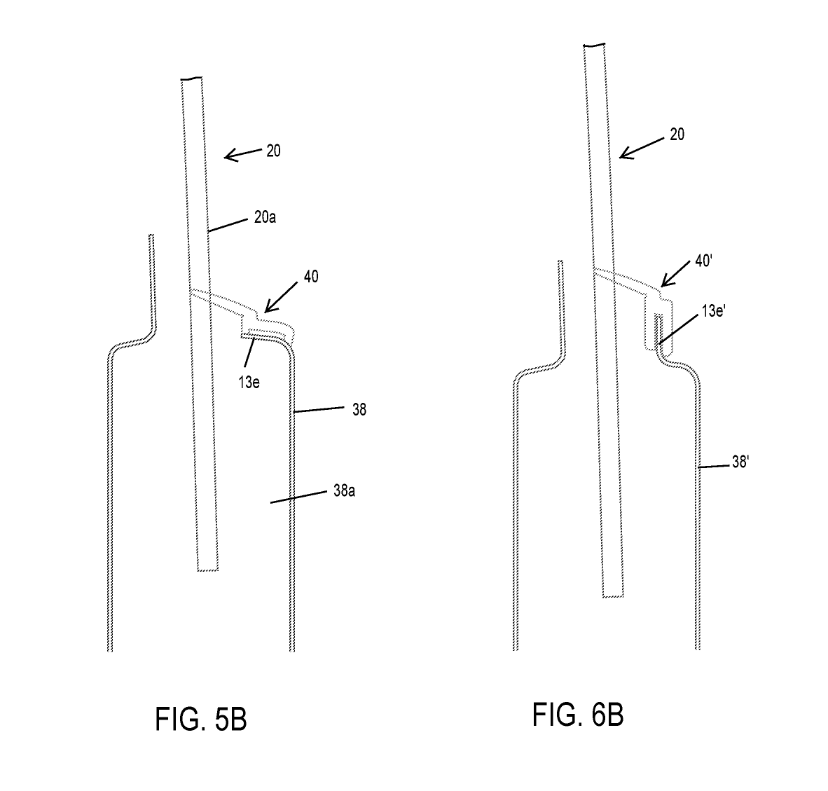

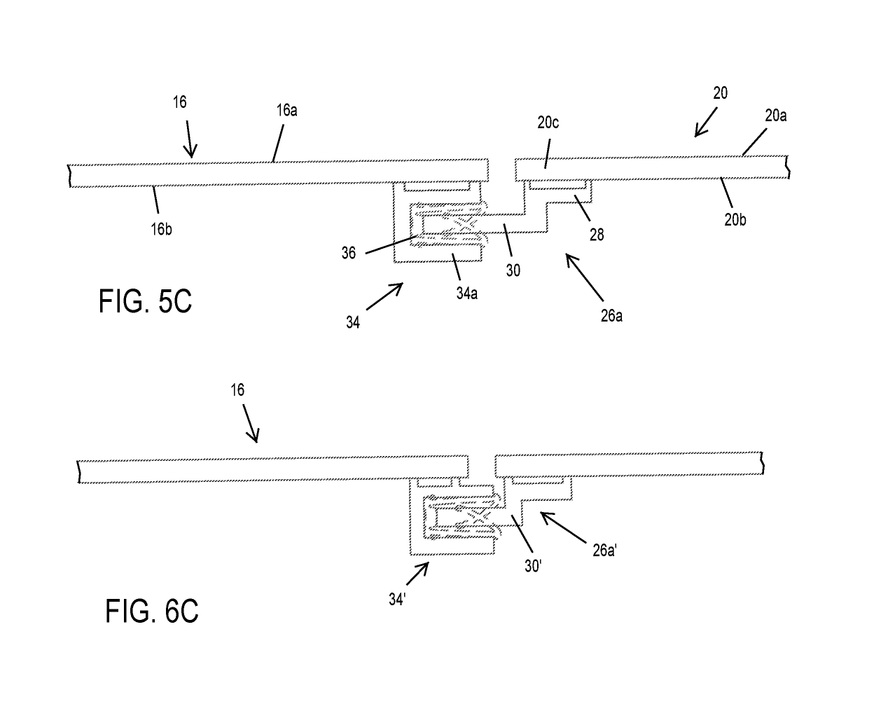

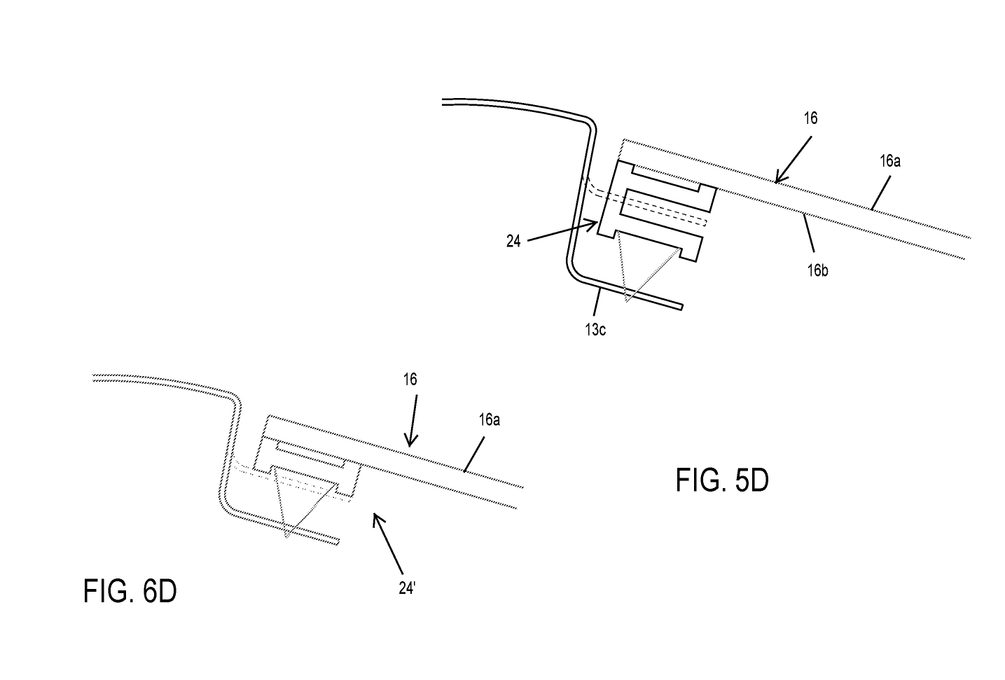

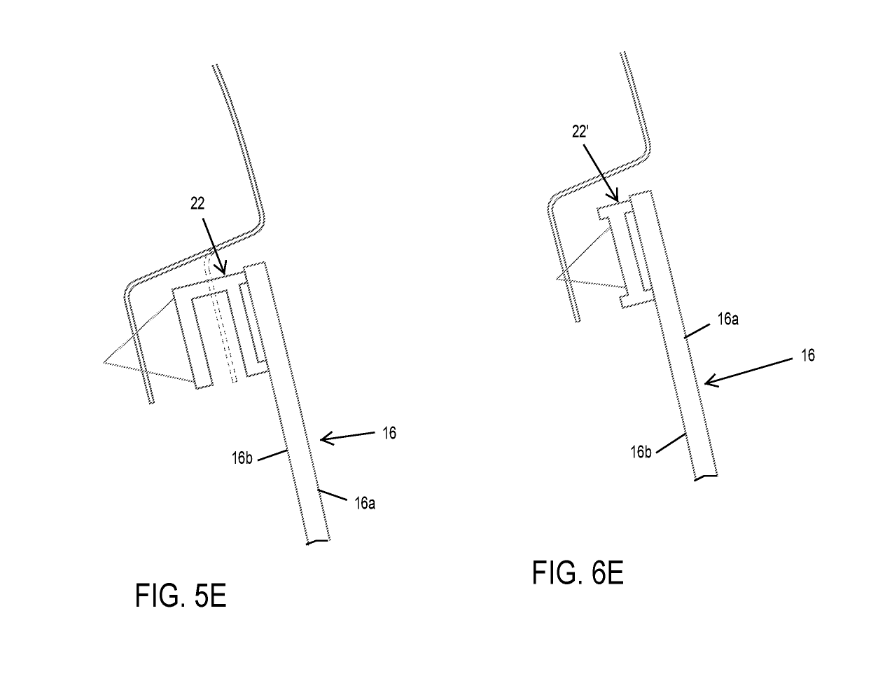

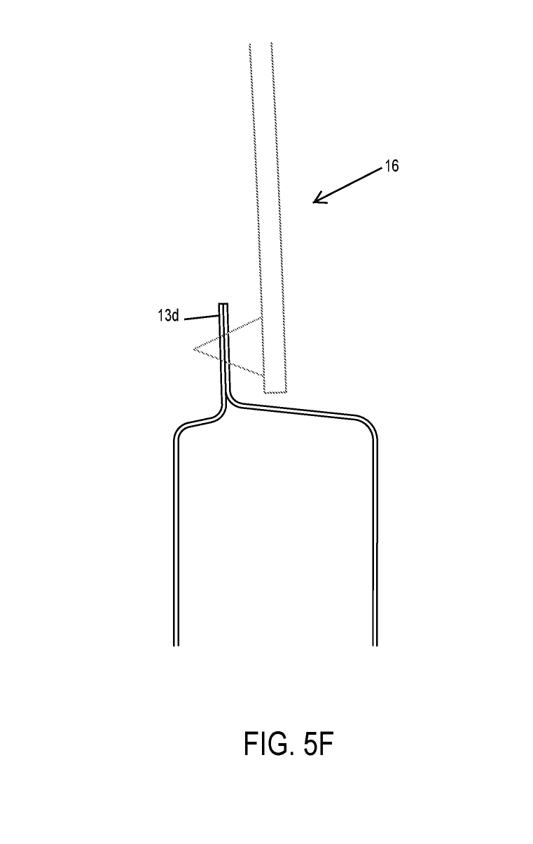

As shown in FIGS. 3, 5A and 5C, the movable window panel 20 includes a guide element 26 adhered or bonded at its interior surface 20b. The guide element 26 includes generally vertical side portions 26a (FIGS. 3 and 5C) that extend along the side perimeter regions of the movable window panel 20 and includes an upper guide element 26b (FIGS. 3 and 5A) that extends along the upper perimeter region of the movable window panel 20. The guide elements 26a, 26b comprise a base or bonding portion 28 that is configured for bonding or adhering to the inner glass surface 20b at or near the perimeter edge of the movable window panel 20 and a tab or leg or protrusion 30 that protrudes outward from the base portion and outward from the perimeter edge of the window panel 20 (such as laterally outward from the side edge region 20c of the window panel 20 as shown in FIG. 5C and upwardly along or from the upper edge region 20d of the window panel 20 as shown in FIG. 5A). The guide elements 26a, 26b may comprise a unitary element 26 (FIG. 3) that is bonded along the side and upper periphery of the interior surface 20b of the movable window panel 20 or may comprise separate elements bonded along respective perimeter regions of the interior surface of the movable window panel.

The upper frame portion 22 of the window assembly 10 includes an upper channel portion 32 (FIG. 5A) that is configured to be bonded or attached at the vehicle sheet metal and that comprises a channel or generally U-shaped receiving portion that is configured to receive the protrusion or lip 30 of the upper guide element 26b when the movable window panel 20 is closed. A sealing element 33 is disposed in the channel portion 32 to enhance sliding and sealing at the protrusion 30 of upper guide element 26b. The upper frame portion 22 is disposed across the upper regions of the fixed window panels and between the fixed window panels, with the channel portion 32 being formed at the upper frame portion at least at the center region between the fixed window panels (where the movable window panel is located). The upper frame portion may provide a continuous channel even at the fixed window panels (see FIG. 5E), where the channel functions as a spacer to set the fixed window panel at a desired location relative to the vehicle sheet metal at which the frame portion is attached.

As shown in FIG. 5A, the upper channel portion 32 may be disposed at a recess or sheet metal flange 13a of the vehicle with the channel 32 being generally at the upper edge region 20d of the window panel 20 when the window panel is closed. Optionally, and such as shown in FIG. 6A, an upper channel portion 32′ may have a base or attaching portion 32b′ that attaches at the sheet metal flange 13a′ and that supports the channel 32a′ at a position lower than the upper edge region 20d of the window panel 20 when the window panel is closed (and in such a configuration, the upper guide element 26b′ may be attached at the window panel at and along a location inboard of the upper edge, as can be seen with reference to FIG. 6A). The configuration of the upper channel portion may depend on the particular application and sheet metal configuration of the vehicle (with the channel portion 32′ of FIG. 6A being suitable for sheet metal applications where the recess or flange is not as deep as compared to the channel portion 32 of FIG. 5A, which is suitable for the deeper or more recessed sheet metal flange shown in FIG. 5A).

The window assembly 10 also includes side channel portions 34 that are bonded or attached at the interior surface 16b of the fixed window panel 16 (only fixed window panel 16 is shown in FIG. 5C, but a similar side channel portion would be adhered at the interior surface of the fixed window panel 18). The side channel portion 34 includes a channel or generally C-shaped receiving portion 34a (that may also include a sealing element 36 disposed therealong) that is configured to movably or slidably receive the protrusions or lips 30 of the side guide elements 26a of the movable window panel 20. As shown in FIG. 5C, the channel portion 34 may be disposed at the side perimeter region of the fixed window panel and the protrusion 30 of the side guide element 26a may extend laterally from the movable panel 20 and may span the gap between the movable panel and the fixed panel. Optionally, and such as shown in FIG. 6C, the channel portion 34′ may partially extend laterally from the fixed window panel 16 and may at least partially span the gap between the movable panel and the fixed panel (whereby the protrusion 30′ of the side guide element 26a′ may be shorter as compared to the side guide element 26a of FIG. 5C).

The protrusions or lips of the side guide elements thus may be slidably or movably received in the side channel portions at the fixed window panels, whereby the movable window panel is movable or slidable along channel portions 34a as the movable window panel 20 is moved between its opened and closed positions, such as via manual movement of the window panel or via powered movement of cables of a movable window drive system that controls powered movement of the movable window panel.

The rear window assembly 10 is configured to be installed at a vehicle via adhesive and/or sealant beads disposed about the upper and side perimeter regions of the window assembly. For example, the frame 14 includes the upper frame portion 22, which may extend across the upper edge regions of the fixed and movable panels. As discussed above, the upper frame portion 22 includes the upper channel or receiving portion 34 at the movable window panel region of the windshield. At the upper side regions (at and along the upper regions of the fixed window panels), the upper frame portion 22 may not have the channel or receiving portion but still functions to attach the window assembly and fixed panels at the vehicle. For example, and such as shown in FIGS. 5D and 5E, the frame 14 includes upper portions 22 and side portions 24 that are configured to be bonded at the sheet metal flanges 13b, 13c and at the inside surface 16b of the fixed window panel 16 (with a similar construction at fixed window panel 18). As can be seen with reference to FIGS. 5D and 5E, the portions 22, 24 are configured to attach the fixed window panel at the vehicle with the width or thickness of the frame portions 22, 24 being selected depending on the depth of the sheet metal flange or recess. In the illustrated embodiment of FIGS. 5D and 5E, the frame portions 22, 24 are generally C-shaped elements to provide greater depth of the frame portions. However, for a shallower sheet metal flange (such as shown in FIGS. 6D and 6E), the frame portions 22′, 24′ may comprise a thinner or non-C-shaped element to attach between the fixed window panel and the sheet metal, while still allowing the outer surface 16a of the fixed panel to be generally flush or recessed within the vehicle sheet metal. Optionally, the thickness of the side frame portions 24 may taper or narrow downwardly towards the lower region of the side fixed window panels, whereby the frame portion may eventually taper to nothing and the fixed window panel may be directly bonded to the vehicle sheet metal flange, such as at the lower side region and/or lower perimeter region of the fixed window panels. Optionally, the side frame portions and upper frame portion (including the channel portion) may be unitarily formed so that a single rail or frame element is adhesively bonded to the vehicle sheet metal during installation of the window assembly.

Optionally, at the lower perimeter regions of the fixed window panels 16, 18, the window panels may be directly bonded to the sheet metal flange 13d of the vehicle, such as shown in FIG. 5F. Optionally, the side frame portions 24 may extend further downward and along a lower region of the fixed window panel to provide an attaching frame at least partially along the lower regions of the fixed window panels.

At the movable window panel 20, and such as shown in FIG. 5B, a structure or housing or sheet metal 38 defines an opening through which the movable window panel 20 is vertically moved or lowered so as to be received in a cavity or receiving portion 38a of the window assembly and vehicle. The side channel portions may extend downwardly into the cavity to guide and support the movable window panel as it is lowered towards its opened position. As also shown in FIG. 5B, a sealing element 40 is disposed at the structure 38, with the sealing element 40 sealing against the outer surface 20a of the movable window panel 20 as it is vertically moved between its opened and closed positions. As can be seen with reference to FIGS. 5B and 5F, the structure 38 may be closed at its upper region at and below the fixed window panels 16, 18, and may be opened below the movable window panel to allow the movable window panel to drop or lower into the cavity. The sealing element 40 may be bonded at a flange 13e of the structure 38 at the opening for the movable window panel, such as shown in FIG. 5B (and the sealing element 40 may extend across the window assembly and may seal against the fixed window panels as well). Optionally, and such as shown in FIG. 6B, the structure 38′ may include an upwardly turned flange 13e′ that the sealing element 40′ may attach to. Clearly, other means for attaching a sealing element or sealing lip at the opening below the movable window panel may be implemented while remaining within the spirit and scope of the present invention.

Thus, the present invention provides a vertically movable window assembly that has generally flush outer glass surfaces of the movable and fixed window panels. The side guide elements and side channel portions are configured to guide the movable window panel relative to the fixed window panels with the adjacent edge regions of the window panels being generally aligned or generally coplanar so that the outer surfaces of the panels are generally flush relative to one another. The guide element may be bonded along the side and upper regions of the movable glass surface and may comprise a single unitarily formed guide element to ease manufacturing of the window assembly. The window assembly of the present invention thus provides a rear window that has an openable and closable movable window panel that, when closed, provides a generally continuous flush glass surface at the rear of the vehicle or pickup truck cab.

Optionally, the vertically movable window assembly may include a single fixed window panel with a hole or aperture formed therethrough (commonly referred to as a hole-in-glass construction) and with the movable window panel being vertically movable between its opened or lowered position and a raised or closed position (where the movable window panel covers or closes over the hole in the fixed window panel. In such a configuration, the vertical channel portions receive protrusions or carriers at either side of the movable window panel (or receive the side edge regions of the movable window panel) to allow for vertical movement along the inner surface of the fixed window panel. The fixed or movable window panel may include a sliding seal or the like that slidably engages the other of the fixed or movable window panel to seal the movable window panel relative to the fixed window panel when the movable window panel is at least partially closed. For example, the fixed window panel may include a sealing element disposed at its inner surface and about the periphery of the hole or aperture, and the movable window panel may slidingly engage the sealing element as the movable window panel moves between its opened and closed positions, whereby, when the movable window panel is fully closed, the movable window panel engages the sealing element about the entirety of the hole or aperture of the fixed window panel. Optionally, a sealing element may be disposed about a perimeter edge region of the outer surface of the movable window panel to slidably engage the inner surface of the fixed window panel as the movable window panel moves between its opened and closed positions. The sealing element or elements may utilize aspects of the sealing systems described in U.S. Publication No. US-2015-0101254, which is hereby incorporated herein by reference in its entirety.

Optionally, the vertical channels of the window assembly may be curved at or near their upper ends, and the movable window panel may include a carrier or frame with pins or followers that move along the channels, whereby the movable window panel may move into the opening of the fixed window panel when closed so as to provide a substantially flush vertical rear slider window assembly. The outer surface of the movable window panel thus may be flush with or generally co-planar with the outer surface of the fixed window panel when the movable window panel is closed. In such a configuration, a sealing element may be disposed at the fixed window panel and about the aperture or may be disposed about the periphery of the carrier of the movable window panel, whereby the sealing element seals relative to the fixed window panel and the movable window panel when the movable window panel is closed. Such a flush window assembly and channels and carrier and sealing elements may utilize aspects of the window assemblies described in U.S. Pat. No. 8,881,458, which is hereby incorporated herein by reference in its entirety.

Thus, vertical rear slider window assembly of the present invention may include a single fixed window panel having an apertures therethrough, with the movable window panel being vertically movable relative to the fixed window panel and aperture. The outer surface of the movable window panel may be substantially flush or co-planar with the outer surface of the fixed window panel when closed, or the movable window panel may be sub-flush or set back relative to the outer window panel, with a sealing element disposed about the aperture and between the inner surface of the fixed window panel and the outer surface of the periphery of the movable window panel when the movable window panel is closed over the aperture of the fixed window panel.

The channels or receiving portions of the upper and side channel portions may comprise any suitable channel element configured to slidably receive the protrusions of the guide elements of the movable window panel. For example, the channel portions and/or the guide elements may be formed via an injection molding process. The channel portions and/or guide elements may be formed via any suitable forming means and may comprise any suitable material or materials, such as, for example, a rigid or substantially rigid molded polymeric material (such as a polyvinylchloride material or PC-ABS or the like), and preferably a rigid polymeric material or engineered plastic material. The channel portions and guide elements may be adhered or bonded to the respective window panels and/or sheet metal via any suitable adhesive, such as, for example, such as by utilizing aspects of the window assemblies described in U.S. Pat. Nos. 5,551,197 and 5,853,895, which are hereby incorporated herein by reference in their entireties.

Optionally, the drive motor assembly may utilize aspects of the drive assemblies of the types described in U.S. Pat. Nos. 4,920,698; 4,995,195; 5,146,712; 5,531,046; 5,572,376; 6,955,009 and/or 7,073,293, and/or U.S. Publication Nos. US-2004-0020131 and/or US-2008-0127563, which are all hereby incorporated herein by reference in their entireties. Optionally, the benefits of embodiments of the present invention may also be realized in vehicular movable window assemblies other than a rear window assembly for a pickup truck or the like, such as (for example) a vertical slider window assembly suitable for use as a movable side window for a vehicle such as a van or a bus.

Optionally, the fixed window panels and movable window panel of the window assembly may include one or more electrically conductive elements, such as heater grids or the like, which may be powered utilizing aspects of the window assemblies described in U.S. Pat. Nos. 8,881,458 and/or 8,402,695, which are hereby incorporated herein by reference in their entireties. The window assembly may include a heater grid on each of the fixed window panels and on the movable window panel, with a heating system that provides power to the heater grid on the movable window panel irrespective of the position of the movable window panel relative to the fixed window panel and throughout the range of movement of the movable window panel between its opened and closed positions, such as via a flexible wire that connects between the heater grid of a fixed window panel and the heater grid of the movable window panel, such as by utilizing aspects of the window assemblies described in U.S. Pat. Nos. 8,881,458 and/or 8,402,695, incorporated above.

Optionally, and desirably, the fixed window panels and the movable window panel may include an opaque coating or layer or frit layer or the like disposed about their respective perimeter regions, in order to conceal or hide or render covert the channels and guide elements and sealing elements disposed at the fixed and movable panels.

Optionally, the window assembly or assemblies of the present invention may utilize aspects of the window assemblies described in U.S. Pat. Nos. 8,915,018; 8,881,458; 8,776,435; 8,402,695; 7,073,293; 7,003,916; 6,691,464; 6,119,401; 6,026,611; 5,996,284; 5,799,444 and/or 6,691,464, and/or U.S. Publication Nos. US-2015-0115649; US-2006-0107600; US-2008-0127563; US-2004-0020131 and/or US-2003-0213179, and/or International Publication Nos. WO 2012/088287 and/or WO 2012/148968, all of which are hereby incorporated herein by reference in their entireties.

Changes and modifications to the specifically described embodiments may be carried out without departing from the principles of the present invention, which is intended to be limited only by the scope of the appended claims, as interpreted according to the principles of patent law.

1. A rear window assembly for a vehicle, said rear window assembly comprising:
an upper frame portion configured to be attached at a vehicle;
side frame portions configured to be attached at the vehicle;
a first fixed window panel having an outer surface and an inner surface, and wherein said upper and side frame portions are attached at said inner surface of said first fixed window panel;
a second fixed window panel having an outer surface and an inner surface, and wherein said upper and side frame portions are attached at said inner surface of said second fixed window panel;
wherein an opening is established between said first and second window panels;
wherein said first window panel has a first side channel disposed along an inboard side region of said inner surface of said first window panel;
wherein said second window panel has a second side channel disposed along an inboard side region of said inner surface of said second window panel;
a movable window panel having an outer surface and an inner surface, wherein said movable window panel includes side guide elements disposed at said inner surface of said movable window panel and along opposite side regions of said movable window panel;
wherein said side guide elements are movably received along said first and second side channels such that said movable window panel is movable between a raised closed position, where the movable window panel is positioned at said opening, and a lowered opened position; and
wherein, when said movable window panel is at least partially closed, said outer surface of said movable window panel is generally flush or generally coplanar with said outer surfaces of said first and second fixed window panels.

2. The rear window assembly of claim 1, wherein said upper frame portion and said side frame portions are unitarily formed via a common forming process.

3. The rear window assembly of claim 2, wherein said side frame portions narrow in thickness towards a lower region of said first and second window panels.

4. The rear window assembly of claim 1, wherein a generally central region of said upper frame portion comprises a receiving portion established generally above said opening, and wherein said movable window panel includes an upper guide element disposed at said inner surface of said movable window panel and along an upper region of said movable window panel, and wherein said receiving portion is configured to receive a portion of said upper guide element when said movable window panel is closed.

5. The rear window assembly of claim 4, wherein said side guide elements and said upper guide element are unitarily formed via a common forming process.

6. The rear window assembly of claim 5, wherein said upper guide element extends upward from said upper region of said movable window panel to engage said receiving portion of said upper frame portion when said movable window panel is in its raised closed position.

7. The rear window assembly of claim 5, wherein said side guide elements extend laterally outward from said side regions of said movable window panel to engage said the respective ones of said first and second side channels.

8. The rear window assembly of claim 7, wherein said side guide elements at least partially span a gap between said movable window panel and the respective fixed window panels.

9. The rear window assembly of claim 4, wherein said side guide elements and said upper guide element are adhesively bonded at said inner surface of said movable window panel, and wherein said first and second side channels are adhesively bonded at said inner surface of said first and second fixed window panels, respectively.

10. The rear window assembly of claim 1, wherein a sealing element is established at a cavity that at least partially receives said movable window panel when said movable window panel is lowered towards its opened position, wherein said sealing element seals against said outer surface of said movable window panel.

11. A rear window assembly for a vehicle, said rear window assembly comprising:
a frame configured to be attached at a vehicle;
wherein said frame comprises first and second side frame portions and an upper frame portion, wherein at least said upper frame portion of said frame comprises a channel portion;
a first fixed window panel having an outer surface and an inner surface, and wherein said first side frame portion and part of said upper frame portion are attached at said inner surface of said first fixed window panel;
a second fixed window panel having an outer surface and an inner surface, and wherein said second side frame portion and another part of said upper frame portion are attached at said inner surface of said second fixed window panel;
wherein an opening is established between said first and second window panels;
wherein said first window panel has a first side channel disposed along an inboard side region of said inner surface of said first window panel;
wherein said second window panel has a second side channel disposed along an inboard side region of said inner surface of said second window panel;
a movable window panel having an outer surface and an inner surface, wherein said movable window panel includes a guide element disposed at said inner surface of said movable window panel and along opposite side regions and an upper region of said movable window panel;
wherein said guide element comprises side guide elements disposed along said side regions of said movable window panel and movably received along said first and second side channels such that said movable window panel is movable between a raised closed position, where the movable window panel is positioned at said opening, and a lowered opened position;
wherein said guide element comprises an upper guide element disposed along said upper region of said movable window panel, and wherein said channel portion of said upper frame portion is configured to receive a portion of said upper guide element when said movable window panel is in its raised closed position; and
wherein, when said movable window panel is at least partially closed, said outer surface of said movable window panel is generally flush or generally coplanar with said outer surfaces of said first and second fixed window panels.

12. The rear window assembly of claim 11, wherein said upper frame portion and said side frame portions are unitarily formed via a common forming process.

13. The rear window assembly of claim 11, wherein said first and second side frame portions narrow in thickness towards a lower region of said first and second window panels.

14. The rear window assembly of claim 11, wherein said side guide elements and said upper guide element of said guide element are unitarily formed via a common forming process.

15. The rear window assembly of claim 11, wherein said upper guide element extends upward from said upper region of said movable window panel to engage said channel portion of said upper frame portion when said movable window panel is in its raised position.

16. The rear window assembly of claim 15, wherein said side guide elements extend laterally outward from said side regions of said movable window panel to engage said the respective ones of said first and second side channels.

17. The rear window assembly of claim 16, wherein said side guide elements at least partially span a gap between said movable window panel and the respective fixed window panels.

18. The rear window assembly of claim 11, wherein said side guide element is adhesively bonded at said inner surface of said movable window panel, and wherein said first and second side channels are adhesively bonded at said inner surface of said first and second fixed window panels, respectively.

19. The rear window assembly of claim 11, wherein a sealing element is established at a cavity that at least partially receives said movable window panel when said movable window panel is lowered towards its opened position, wherein said sealing element seals against said outer surface of said movable window panel.

20. The rear window assembly of claim 11, wherein said frame comprises a continuous frame having a curved transition between said upper frame portion and said first and second side frame portions.
